(19) United States
(12) Patent Application Publication
(10) Pub. No.: US 2014/0171328 A1
(43) Pub. Date: Jun. 19, 2014

(54) NOVEL COMPOSITE

(71) Applicant: REVOLYMER (U.K.) LIMITED, Deeside, Flintshire (GB)

(72) Inventors: Stephen Armstrong, Fintshire (GB); Terence Cosgrove, Flintshire (GB); John Jeffrey Gerrard, Flintshire (GB); Melanie Jane Hughes, Flintshire (GB); David Alan Pears, Flintshire (GB)

(73) Assignee: REVOLYMER (U.K.) LIMITED, Deeside, Flintshire (GB)

(21) Appl. No.: 14/111,964

(22) PCT Filed: Apr. 13, 2012
(86) PCT No.: PCT/GB2012/050819

§ 371 Date: Feb. 25, 2014

(30) Foreign Application Priority Data
Apr. 15, 2011 (GB) 1106408.6

(51) Int. Cl. C11D 17/00; A01N 25/26

(52) U.S. Cl. CPC C11D 17/0039; A01N 25/26
USPC 504/361; 510/400; 510/445; 510/446; 510/375; 510/392; 510/221; 510/224; 510/337; 510/276; 510/438; 424/497

(57) ABSTRACT

A novel composite including one or more core units, each core unit including a specified active agent and having pH responsive, vinylic copolymer coating, to a process for the preparation of such a composite, to formulations including the same and their use in a variety of industrial applications.

The present invention relates to a novel composite comprising one or more core units, each core unit comprising a specified active agent and having a pH responsive, vinylic copolymer coating, to a process for the preparation of such a composite, to formulations comprising the same and their use in a variety of industrial applications.

The practice of protecting active agents from an incompatible environment by physical separation, for example, by encapsulation is well established. Separation techniques may be employed for a wide variety of reasons, including protecting active agents from oxidation, preventing volatile losses, preventing chemical reaction or improving the handling characteristics of difficult to handle active agents and materials. Even when the objective of the encapsulation is the isolation of the core from its surroundings, the protective coating or shell must be ruptured at the time of desired action. The rupturing of the protective coating or shell is typically brought about through the application of chemical and physical stimuli such as pressure, shear, melting, response to changing solvent conditions, solvent action, enzyme attack, chemical reaction and physical disintegration.

The present invention is concerned with the use of protective polymeric coatings which, when applied to one or more core units comprising an active agent form a composite, designed to rupture as a consequence of a change in solvent conditions, in particular, on exposure to an alkaline aqueous environment of pH 7.5. The use of such polymeric coatings advantageously enables a wide variety of active agents to be co-formulated with other active and/or non-active agents with which they would otherwise be incompatible, i.e. their inclusion in the same formulation would, in the absence of a protective coating, undesirably result in the chemical degradation of one or more of the active agents present.

By way of example, the composites of the invention may be employed in solid and liquid cleaning formulations, including bleaching compositions. Bleaching compositions frequently contain peroxy acid oxidising (or bleaching) agents of general formula (1):

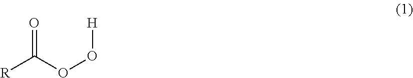

where R is a linear, branched or cyclic, aliphatic or aromatic, saturated or unsaturated, substituted or unsubstituted organic moiety containing two or more carbon atoms. Peroxy acids act as bleaching agents upon decomposition to afford oxygen radicals or “active oxygen” as follows:

2R—CO—O—O—H→2R—CO—OH+2O⁻

Decomposition may be initiated by exposure to various physical (mechanical and/or thermal) stresses, is facilitated by the presence of water and may be strongly exothermic.

Phthalimido peroxy alkanoic acids of formula (2) are an example of a class of commercially available peroxy acids that are commonly used in cleaning formulations

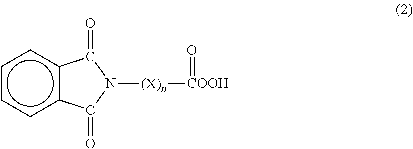

where X is a linear or branched, substituted or unsubstituted hydrocarbon chain having at least one carbon atom and n is an integer, typically in the range from 1 to 5.

Phthalimido peroxy hexanoic acid (PAP) of formula (3):

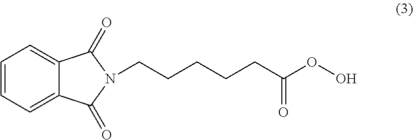 [SMILES: O=C(CCCCCN1C(=O)c2ccccc2C1=O)OO]

is an example of a phthalimido peroxy alkanoic acid that has been shown to possess particularly good bleaching properties (“PAP: the bleaching agent for low temperature washing”; Elena Negri, Ausimont S.p.A., Italy—page 29 of “comitato italiano dei derivati tensioattivi”—ATTI delle 9^{e} Giornate CID, Venezia, 13-15 giugno 2001).

Peroxy acid bleaching agents are employed in a variety of cleaning formulations including laundry and dishwasher cleaning compositions. Such compositions typically comprise, in addition to a bleaching agent, a number of other active and non-active components such as surfactants, enzymes and mixtures thereof. The compositions may be in liquid or solid form. The inclusion of bleaching agents such as peroxy acids in the same composition with enzymes and other components sensitive to oxidation, although desirable from a cleaning perspective, is problematic since these species tend to react with one another resulting in the loss of active oxygen from the bleaching agent and denaturing of the enzyme.

This incompatibility problem has previously been addressed by formulating and packaging the bleaching agent and the enzyme in such a way that the two components are separated (so-called two chamber products) and only mixed either upon dispensing or upon dissolution of a protective pouch, for example as used in the commercially available products Fairy Platinum (Proctor & Gamble, Cincinnati, USA) and Finish Quantum (Reckitt Benckiser, Hull, UK) dishwasher tablets. Although such products have the capability to act upon both bleachable and enzymatically degradable stains, this is only achieved with significant additional manufacturing and packaging costs compared to single chamber products. Packaging methods of this type place many practical constraints on total product design; limiting freedom in active agent selection and the need to incorporate active agents into specific compartments.

It would be highly desirable to provide a single chamber product capable of housing two or more otherwise incompatible active agents such as a bleaching agent and an enzyme, whilst maintaining or improving the properties possessed by the product, such as providing enhanced cleaning properties.

The coating and encapsulation of detergent components with various inorganic and organic materials has been documented in the art. For example, WO94/15010 (The Proctor & Gamble Company) discloses a solid peroxy acid bleach precursor composition in which particles of peroxy acid bleach precursor are coated with a water-soluble acid polymer, defined on the basis that a 1% solution of the polymer has a pH of less than 7.

WO94/03568 (The Proctor & Gamble Company) discloses a granular laundry detergent composition having a bulk density of at least 650 g/I, which comprises discrete particles comprising from 25-60% by weight of anionic surfactant, inorganic perhydrate bleach and a peroxyacid bleach precursor, wherein the peroxy acid bleach precursor is coated with a water soluble acidic polymer.

U.S. Pat. No. 6,225,276 (Henkel Kommanditgesellschaft auf Aktien) discloses a solid particulate detergent composition comprising a coated bleaching agent that dissolves in water irrespective of pH, a bleach activator coated with a polymeric acid that only dissolves at pH values above 8, and an acidifying agent.

U.S. Pat. No. 5,972,506 (BASF Aktiengesellschaft) discloses microcapsules containing bleaching agents. The microcapsules are obtained by polymerizing a mixture of monomers in the oil phase of a stable oil-in-water emulsion in the presence of free radical polymerization initiators.

WO97/14780 (Unilever NV) discloses an encapsulated bleach particle comprising a coating including a gelled polymer material, and a core material which is selected from a peroxygen bleach compound, a bleach catalyst and a bleach precursor. The gelled polymer has a molecular structure that is partially or fully cross-linked, such as for example, agar, alginate, carrageenan, casein, gellan gum, gelatine, pectin, whey proteins, egg protein gels and the like.

WO98/16621 (Warwick International Group Ltd) discloses a process for encapsulating a solid detergent component from an oil-in-water emulsion by forming a polymer film at the oil/water interface by condensation polymerisation. Suitable polymer films include polyamide, polyester, polysulphonamide, polyurea and polyurethane.

WO98/00515 (The Proctor & Gamble Company) discloses non-aqueous, particulate-containing liquid laundry cleaning compositions which are in the form of a suspension of particulate material comprising peroxygen bleaching agents and coated peroxygen bleach activators. The coating material is soluble in water, but insoluble in non-aqueous liquids, and is selected from water soluble citrates, sulfates, carbonates, silicates, halides and chromates.

WO93/24604 (BP Chemicals Ltd) discloses an encapsulated active substrate comprising a bleach and/or a bleach activator releasably encapsulated in a coating of an alkali metal carbonate or bicarbonate and an outer encapsulating coating of a metal salt of an inorganic salt.

U.S. Pat. No. 6,107,266 (Clariant GmbH) discloses a process for producing coated bleach activating granules in which bleach activator base granules are coated with a coating substrate and are simultaneously and/or subsequently thermally conditioned. The coating substance is selected from C₈-C₃₁ fatty acids, C₈-C₃₁ fatty alcohols, polyalkylene glycols, non-ionic surfactants and anionic surfactants.

According to a first aspect of the present invention, there is provided a composite comprising one or more core units, each core unit comprising an active agent and having a pH responsive, vinylic copolymer coating, wherein said active agent is selected from the group consisting of bleaching agents, anti-foaming agents, anti-redeposition aids, anti-microbials and biocides, enzymes, bleach catalysts, dye transfer inhibitors, optical brighteners, dyes, pigments, anti-scale and corrosion inhibiting ingredients, fragrances and perfumes, glass protectors, crop protection agents and agrochemicals such as pesticides, herbicides, insecticides, fungicides, fertilizers, hormones and chemical growth agents, and mixtures thereof.

Such composites may be placed in liquid product environments of pH<7.5 in which the polymeric coating is indefinitely stable. When the liquid and solid products are dispersed or diluted in water, to realise conditions of greater alkalinity, i.e. pH≧7.5, the protective polymeric coating is compromised, by dissolution, dissolving, rupturing or swelling, and the core material released into the surrounding environment. The novel composites of the present invention are of potential value to numerous consumer and industrial products as further detailed herein.

The composite of the invention comprises one or more core units. The core unit may be in solid or liquid form, and may comprise single discrete particles, agglomerated particles, matrix particles and/or spheronised compositions.

When the core unit comprises one or more spheronised compositions, these may be prepared using a spheronising aid. Examples of suitable spheronising aids include microcrystalline cellulose, carboxymethyl-cellulose, hydroxyethylcellulose and pH responsive polymers as described herein.

The core unit(s) typically comprise from about 10% to about 90% of the total composite mass.

The core unit(s) preferably comprise one or more active agents. The active agent may be in solid or liquid form. When the active agent is in liquid form, it is preferably adsorbed onto an inert solid prior to encapsulation. The active agent may be present in an amount from about 0.5 to 100% of the total core unit mass. Preferably, the active agent is present in an amount from about 0.5% to about 90% of the total core unit mass. The amount of active agent(s) present in the core units will be dependent upon the type of active agent employed.

In one embodiment of the invention, the active agent is a bleaching agent or a mixture thereof. As used herein the term “bleaching agent” means a liquid or solid chemical compound that may be used to whiten or brighten various substrates and/or remove soil from them. Examples of suitable bleaching agents include mono- and diperoxy acids and mixtures thereof.

Examples of suitable monoperoxy acids include peroxybenzoic acid, ring-substituted peroxybenzoic acids, aliphatic monoperoxy acids, substituted aliphatic monoperoxy acids, mono-peroxyphthalic acids, and mixtures thereof. Preferred examples of monoperoxy acids include peroxy-alpha-naphthoic acid, peroxylauric acid, peroxystearic acid, peroxyformic acid, peroxyacetic acid, peroxypropionic acid, peroxyhexanoic acid, peroxybenzoic acid, nonylamidoperoxyadipic acid, 6-hydroxyperoxyhexanoic acid, 4-phthalimidoperoxybutanoic acid, 5-phthalimidoperoxypentanoic acid, 6-phthalimidoperoxyhexanoic acid (PAP), 7-phthalimidoperoxyheptanoic acid, N,N′-terephthaloyl-di-6-aminoperoxyhexanoic acid, and mixtures thereof.

Examples of suitable diperoxy acids include alkyl and aryl diperoxy acids, including di-peroxyphthalic acids, and mixtures thereof. Preferred examples of diperoxy acids include 1,12-diperoxydodecanedioic acid, 1,9-diperoxyazelaic acid, diperoxybrassylic acid, diperoxyseabacic acid, diperoxyoxyiso-phthalic acid, 2-decyldiperoxybutane-1,4-dioic acid, and mixtures thereof.

In a preferred embodiment, the bleaching agent is a peroxy acid as defined in formula (1) above or a mixture thereof. More preferably, the peroxy acid bleaching agent is a phthalimido peroxy alkanoic acid bleaching agent as defined in formula (2) above or a mixture thereof. Most preferably, the bleaching agent is PAP.

In an alternative embodiment of the invention, the active agent is an anti-foaming agent or a mixture thereof. Examples of suitable anti-foaming agent examples include soaps of natural or synthetic origin which have a high content of C₁₈₋₂₄ fatty acids; organopolysiloxanes and mixtures thereof with microfine, optionally silanized silica; alkyl ethoxylate non-ionic surfactants; and paraffins, waxes, microcrystalline waxes and mixtures thereof with silanized silica or bis-stearyl ethylenediamide, and mixtures thereof. In a preferred embodiment of the invention, the anti-foaming agent is a paraffin, a bis-stearyl ethylenediamide, or a mixture thereof. The anti-foaming agent is preferably loaded onto a granular, water-soluble or dispersible carrier material of the type described herein.

In an alternative embodiment of the invention, the active agent is an anti-redeposition aid or a mixture thereof. Examples of suitable anti-redeposition aids include organic polymeric compounds such as, but not limited to, ethoxylated polyamines, polycarboxylic acids, modified polycarboxylates or their salts or copolymers with any suitable other monomer units including modified acrylic, fumaric, maleic, itaconic, aconitic, mesaconic, citraconic and methylenemalonic acid or their salts, maleic anhydride, acrylamide, alkylene, vinylmethyl ether, styrene, and mixtures thereof. Preferred commercially available anti-redeposition aids include TexCare© anionic polyester polymers (Clariant), Sokalan® polyacrylate copolymers (BASF) and Acusol® acrylic acid polymers (The Dow Chemical Co.).

In an alternative embodiment of the invention, the active agent is an antimicrobial agent or a mixture thereof. Examples of suitable antimicrobial agents include, but are not limited to, o-phenylphenol, bromonitropropane diol, tris(hydroxymethyl)nitromethane, octadecylaminidimethyltrimethoxysilylpropylammonium chloride, silver zeolite, benzoimidazole, 2-(4-thiazolyl)-2,6-dimethyl-1,3-dioxan-4-ol acetate, Hinokitiol, propene nitriles, 2,4,4′-trichloro-2′-hydroxydiphenylether, cyclopropyl-N′-(1,1-dimethylethyl)-6-(methylthio)-1,3,5-triazine-2,4-diamine, zinc oxide, 1-aza-3,7-dioxa-5-ethyl-bicyclo-(3,3,0)-octane, 2-bromo-2-nitro-1,3-propanediol, 2-(hydroxylmethyl)-2-nitro-1,3-propanediol, 2,2-dibromo-propanediamide, 2,4,4′-trichloro-2-hydroxydiphenyl ether, 4,4′-dichloro-2-hydroxydiphenyl ether, tetrakis(hydroxymethyl)phosphonium sulphate, and mixtures thereof.

In an alternative embodiment of the invention, the active agent is an enzyme or a mixture thereof. Examples of suitable enzymes include amylases, arabinosidases, blucoamulases, cellulases, chondroitinases, cutinases, esterases, hydrolases, hemicellulases, isomerases, keratinases, lassases, lignases, lipases, lipooxygenases, lyases, malanases, mannanase, oxidases, oxidoreductases, pectinases, pentosanases, peroxidases, phenoloxidases, phospholipases, proteases, pullulanases, reductases, R-glucanases, tannases, transferases, xylanases, and mixtures thereof.

“Enzyme variants” produced, for example, by recombinant techniques are also included within the meaning of the term “enzyme” as used herein. Examples of suitable enzyme variants include those compounds disclosed in EP0251446A (Genencor), WO91/00345 (Novo Nordisk), EP0525610A (Solvay) and WO94/02618 (Gist-Brocades).

Core units comprising one or more enzymes may be produced by a variety of techniques known in the art. Suitable methods include those disclosed in DE2137042 (Novo Terapeutisk Laboratorium), U.S. Pat. No. 4,087,368 (Colgate Palmolive), U.S. Pat. No. 4,016,040 (Colgate Palmolive), U.S. Pat. No. 4,242,219 (Gist-Brocades), U.S. Pat. No. 4,009,076 (Lever Brothers), U.S. Pat. No. 4,689,297 (Miles Laboratories), UK1361387A (Novo Terapeutisk Laboratorium), U.S. Pat. No. 3,749,671 (P&G), U.S. Pat. No. 5,324,649 (Genencor) and U.S. Pat. No. 3,277,520 (Fuji Denki Kogyo Kabushiki Kai).

A number of suitable enzyme-containing core materials are commercially available; examples include Stainzyme® (amylase), Esperase® (protease), Alcalase® (protease), Termamyl® (amylase), Fungamyl® (amylase) and Lipolase® (lipase) which are available from Novozymes. Further examples include Purafect® (protease), Properase® (protease), Purastar® (Amylase), Puradex® (Cellulase) and Purabrite® (Mannanase), which are available from Genencor.

In an alternative embodiment of the invention, the active agent is a bleach catalyst or a mixture thereof. Examples of suitable bleach catalysts include transition metal bleach catalysts containing either manganese or cobalt. A preferred bleach catalyst is penta amine acetatcobalt (III) nitrate (PAAN). Further preferred types of bleach catalysts include the manganese-based complexes disclosed in U.S. Pat. No. 246,621 and U.S. Pat. No. 5,244,594 and those described in EP0549272A. Preferred ligands for use in preparing transition metal based bleach catalysts include 1,5,9-trimethyl-1,5,9-triazacyclododecane, 2-methyl-1,4,7-triazacyclononane, 2-methyl-1,4,7-triazacyclononane, 1,2,4,7-tetramethyl-1,4,7-triazacyclononane, and mixtures thereof.

In an alternative embodiment of the invention, the active agent is a polymeric dye transfer inhibiting agent or a mixture thereof. Examples of suitable polymeric dye transfer inhibiting agents include polyamine N-oxide polymers, copolymers of N-vinylpyrrolidone and N-vinylimidazole, polyvinylpyrrolidonepolymers, and mixtures thereof.

In an alternative embodiment of the invention, the active agent is an optical brighter or a mixture thereof. Examples of suitable optical brighteners include 4,4′-bis[(4-anilino-6-(N-2-hydroxyethyl-N-methylamino)-s-triazine-2-yl)amino]2,2′-stilbenedisulfonic acid, disodium salt (Tinopal 5BM-GX, Ciba-Geigy Corporation), 4,4′,-bis[(4-anilino-6-(N-2-bis-hydroxyethyl)-s-triazine-2-yl)amino]-2,2′-stilbenedisulfonic acid, disodium salt (Tinopal-UNPA-GX, Ciba-Geigy Corporation), 4,4′-bis[(4-anilino-6-morphilino-s-triazine-2-yl)amino]2,2′-stilbenedisulfonic acid, sodium salt (Tinopal AMS-GX, Ciba-Geigy Corporation), and mixtures thereof.

In an alternative embodiment of the invention, the active agent is a dye or a mixture thereof. Examples of suitable dyes include dyes that have high aesthetic effect but do not discolour laundered textiles; such as azo dyes, anthraquinone dyes, benzofuranone dyes, polycyclic aromatic carbonyl dyes containing one or more carbonyl groups linked by a quinoid system, indigoid dyes, polymethine and related dyes, styryl dyes, di- and tri-aryl carbonium and related dyes, such as diphenylmethane, methylene blue, oxazine and xanthene types; phthalocyanines, such as those di- and trisulfonated derivatives; quinophthalones, sulphur dyes and nitro-dyes, and mixtures thereof. Preferred dyes are those which possess low fastness to textiles, i.e. “non-staining” dyes.

In an alternative embodiment of the invention, the active agent is a pigment or a mixture thereof. Examples of suitable pigments include titanium dioxide, natural or synthetic mica, silica, tin oxide, iron oxide, rutile, chromium dioxide, aluminium oxide, zirconium oxide, bismuth oxychloride, and mixtures thereof.

In an alternative embodiment of the invention, the active agent is an anti-scale or corrosion inhibition ingredient, or a mixture thereof. Examples of suitable anti-scale or corrosion inhibition ingredients include amino trimethylene phosphonic acid, 1-hydroxy ethylidene-1,1-diphosphonic acid, ethylene diamine tetra(methylene phosphonic acid) sodium, ethylene diamine tetra(methylene phosphonic acid), diethylene triamine penta(methylene phosphonic acid), polyaspartic acid sodium salt, polyepoxysuccinic acid, polyacrylic acid, acrylic acid-2-acrylamido-2-methylpropane sulfonic acid copolymer, acrylic acid-2-hydroxypropyl acrylate copolymer, and mixtures thereof.

In an alternative embodiment of the invention, the active agent is a fragrance or perfume, or a mixture thereof. Examples of suitable fragrances or perfumes include those disclosed in U.S. Pat. No. 4,534,891, U.S. Pat. No. 5,112,688, U.S. Pat. No. 5,145,842 and “Perfumes Cosmetics and Soaps”, Second Edition, edited by W. A. Poucher, 1959. Preferred examples include acacia, cassie, chypre, cylamen, fern, gardenia, hawthorn, heliotrope, honeysuckle, hyacinth, jasmine, lilac, lily, magnolia, mimosa, narcissus, freshly-cut hay, orange blossom, orchids, reseda, sweet pea, trefle, tuberose, vanilla, violet, wallflower, and mixtures thereof.

In an alternative embodiment of the invention, the active agent is a glass protection ingredient. Examples of suitable glass protection ingredients include zinc, either in metallic form (such as described in U.S. Pat. No. 3,677,820) and compounds/complexes thereof; bismuth and compounds/complexes thereof (such as those described in BE860180); mixtures of zinc and bismuth (such as those described in EP2194115A); and polyalkyleneimines and/or salts or derivatives thereof (such as those disclosed in WO2010/020765).

In an alternative embodiment of the invention, the active agent is a crop protection agent or an agrochemical including, but not limited to, pesticides, herbicides, insecticides, fungicides, (examples of which are found in WO01/94001) fertilizers (examples of which are referenced in WO2009/023235), hormones and chemical growth agents (examples of which are found in US2005197253).

The contents of the above-mentioned patents/applications are incorporated herein by reference as if each individual publication was specifically and fully set forth herein.

Particulate cores comprising an active agent may be formed by agglomeration, granulation, spheronisation and other techniques known in the art, for example as described in “Agglomeration Processes: phenomena, technologies, equipment”, Wolfgang Pietsch (2002), John Wiley & Sons.

In addition to one or more active agents, the core units may comprise one or more non-active components such as one or more suitable carriers, lubricants binders and/or fillers.

Examples of suitable carriers include macro-porous beads, preferably those prepared from a polyacrylic matrix, a polystyrene matrix, a polypropylene matrix or a silica matrix, swellable clays such as Bentonite, and cellulose derivatives such as carboxy methyl cellulose, and mixtures thereof.

Examples of suitable lubricants include ethoxylated alcohol, preferably Genapol® OX 070, block copolymers of ethylene oxide and propylene oxide, poloxamers, preferably Pluronic® block copolymers, such as Pluronic® L101 and Pluronic® L121, and Synperionc® PE/L61, and mixtures thereof.

Examples of suitable binders include polysaccharides such as microcrystalline cellulose, preferably Comprecel® M101, carboxymethyl cellulose, preferably Aquasorb® A380, hydroxyl ethyl cellulose, preferably Natrosol® 250HHR, hydroxypropyl cellulose, preferably Klucel® HCS, and pH responsive polymers as described herein, and mixtures thereof.

Examples of suitable fillers include polysaccharides such as microcrystalline cellulose, preferably Comprecel® M101, carboxymethyl cellulose, preferably Aquasorb® A380, hydroxyl ethyl cellulose, preferably Natrosol® 250HHR, and hydroxypropyl cellulose, preferably Klucel® HCS. Additional examples of fillers include inorganic materials such as talc, clays, including Bentonite clays, and salts such as sodium chloride and sodium sulphate, and mixtures thereof.

The present invention provides a composite in which one or more core units comprising an active agent are coated with a pH responsive, vinylic copolymer. The protective coating encapsulates the core unit(s) and enables otherwise incompatible active agents to be co-formulated.

The pH responsive, acrylic co-polymer typically comprises from about 10% to about 90% of the total composite mass.

As used herein “encapsulation” means the application of a continuous polymeric coating to completely surround a small solid particle or liquid droplet to give a core-shell structure. The polymer coated particles (i.e. composites) of the invention are typically spherical (or approximately spherical) and suitably have a particle diameter (maximum dimension) in the range of from about 50 μm to about 2500 μm, preferably in the range from about 250 μm to about 1500 μm, and most preferably in the range from about 500 μm to about 1250 μm.

The core units are coated with one or more pH responsive, vinylic copolymers which are insoluble at acidic and neutral pH values (preferably below their pKₐ value) and soluble at basic pH values (preferably at or above their pKₐ value). Preferably, the pH responsive, vinylic copolymer is soluble at pH Such copolymers are referred to herein as “alkali soluble copolymers”.

The composite of the invention comprises a coating of either a single pH responsive, vinylic copolymer or mixtures of such polymers. Where the active agent in the core unit is a bleach and/or an enzyme, the resulting composite is of sufficient stability to permit its incorporation into acidic or neutral liquid detergent media intended for domestic, commercial and institutional use, where the media may be unstructured or structured and include either no water or some water. In such instances the polymer coating is insoluble in the product environment and presents an effective barrier to the components of the medium including anionic, nonionic and cationic surfactants, active oxygen bleaching agents, hydrogen peroxide, water and any other additives, but is soluble in the alkaline wash environment, whereupon the bleach and/or enzyme will be released.

The composites of the present invention typically contain from about 10% to about 75%, preferably from about 15% to about 50% and more preferably from about 25% to about 40% of said pH responsive, vinylic copolymer coating by weight of the total composite.

Preferably, the coating is present in a thickness of from about 5 μm to about 90 μm, more preferably about 8 μm to about 40 μm and most preferably from 15 μm to 30 μm.

In a preferred embodiment of the invention, at least a portion of the core units are completely encapsulated by the pH responsive, vinylic copolymer coating. More preferably, substantially all, or all, of the core units are completely encapsulated by the pH responsive, vinylic copolymer coating. However, the invention also encompasses composites in which at least a portion of the core units are only partially coated, for example, composites in which at least a proportion of the core units are partially coated to a sufficient degree to still exhibit the desired functional characteristics of the invention, namely, so that the coating presents an effective barrier to the remaining components of the medium, but is soluble in an alkaline environment.

Preferably, the pH responsive, vinylic copolymer is prepared from monomers having only one polymerisable double bond. Examples of suitable monomers having only one polymerisable double bond include, but are not limited to, acrylic acid (AA), methacrylic acid (MAA), beta carboxy ethyl acrylate (BCEA), itaconic acid, maleic acid, maleic anhydride, itaconic anhydride, styrene and substituted styrenes such as α-methyl styrene, methyl styrene, t-butyl styrene, alkyl esters of mono-olefinically unsaturated dicarboxylic acids such as di-n-butyl maleate and di-n-butyl fumarate; vinyl esters of carboxylic acids such as vinyl acetate, vinyl propionate, vinyl laurate and vinyl esters of versatic acid such as VeoVa® 9 and VeoVa® 10; acrylamides such as methyl acrylamide and ethyl acrylamide; methacrylamides such as methyl methacrylamide and ethyl methacrylamide; nitrile monomers such as acrylonitrile and methacrylonitrile; and esters of acrylic and methacrylic acid, preferably optionally substituted C₁₋₂₀alkyl and C₁₋₂₀cycloalky esters of acrylic and methacrylic acid, such as methyl acrylate, ethyl acrylate, n-butyl acrylate, 2-ethylhexyl acrylate, i-propyl acrylate, and n-propyl acrylate, methyl methacrylate, ethyl methacrylate, n-butyl methacrylate, 2-ethylhexyl methacrylate, i-propyl methacrylate, n-propyl acrylate, hydroxyethyl acrylate, hydroxyethyl methacrylate, hydroxyl butyl methacrylate, N,N-dimethylaminoethyl acrylate and N,N-dimethylaminoethyl methacrylate, diacetone acrylamide, glycidyl methacrylate, aceto acetoxy ethyl methacrylate, and mixtures thereof.

More preferably, the pH responsive, vinylic copolymer is formed from monomers selected from methyl methacrylate (MMA), ethyl methacrylate (EMA), n-butyl methacrylate (BMA), iso-butyl methacrylate (iBMA), 2-ethylhexyl methacrylate (EHMA), 2-ethylhexyl acrylate (EHA), iso-bornyl methacrylate (iBoMA), methyl acrylate (MA), ethyl acrylate (EA), n-butyl acrylate (BA), styrene (STY), acrylic acid (AA), methacrylic acid (MAA), β-carboxy ethyl acrylate (β-CEA), and sodium acrylate (SAA), and mixtures thereof.

Preferably, the pH responsive, vinylic copolymer has a molecular weight of from about 20,000 Daltons to about 500,000 Daltons, more preferably from about 40,000 Daltons to about 250,000 Daltons.

Preferably, the pH responsive, vinylic copolymer possesses a pKₐ value of from 3.0 to 10.0, more preferably from about 4.5 to about 9.5 and most preferably from about pH 6 to about pH 9.

Preferably, the pH responsive, vinylic copolymer has a glass transition temperature of from about −40° C. to about 100° C., more preferably from about 10° C. to about 80° C.

Preferably, the pH responsive, vinylic copolymer demonstrates a minimum film forming temperature of from about 0° C. to about 100° C., more preferably from about 10° C. to about 80° C.

In one preferred embodiment, the pH responsive, vinylic copolymer is a random copolymer. In another preferred embodiment, the pH responsive, vinylic copolymer is a block copolymer.

Preferably, the pH responsive, vinylic copolymer is prepared from a mixture of at least one dissociating monomer and at least one non-dissociating monomer.

As used herein, the term “dissociating monomer” refers to a monomer that gives rise to polymer chains characterised by the presence of a carboxylic acid residue (—CO₂H). The following acid-base dissociation may be described:

—CO₂H [symbol] -CO₂⁻+H⁺

This equilibrium is characterised by its pKₐ value.

Under acidic conditions (e.g. where pH<pKₐ), an uncharged carboxylic acid (—CO₂H) residue is encountered, which will render an uncharged and insoluble polymer chain, essential to the protection of the active agent-containing core units of the composite. However, under alkaline conditions (e.g. where pH>pKₐ), a charged anionic carboxylate group (—CO₂⁻) will be encountered, which gives rise to a charged and readily water soluble polymer backbone, essential for the release of the active agent(s) from the core units.

Preferred examples of dissociating monomers include acrylic acid (AA), methacrylic acid (MAA) and β-carboxyethyl-acrylate (BCEA).

As used herein, the term “non-dissociating monomer” refers to a monomer that contains a —CO—OR⁶ group, where R⁶ is other than hydrogen (e.g. where R⁶ is an inert aliphatic or aromatic organic moiety) or a monomer of formula R³R⁴C═CR⁵R⁶, where R³, R⁴ and R⁵ are each independently hydrogen or an inert aliphatic or aromatic organic moiety, thus the monomer is not capable of acid-base dissociation. The chemical/physical characteristics of the non-dissociating monomer segments of the polymer chains are independent of pH. They are typified by monomers such as EA, BA, BMA, EHA, STY, MMA and the like. Preferably, the copolymer backbone is formed from more than one non-dissociating co-monomer to ensure an adequate balance of physical (minimum film forming and glass transition temperatures) and barrier properties.

In a particularly preferred embodiment of the invention, the pH responsive, vinylic copolymer is a (meth)acrylic copolymer of general formula I:

—[(X)ₓ—(Y)_{y}—(Z)_{z}]— (I)

wherein:
—(X)ₓ—(Y)_{y}—(Z)_{z}— is a polymer backbone formed from the polymerization of X′, Y′ and Z′ monomers;
X′ is a first non-dissociating monomer of formula R³R⁴C═CR⁵—CO—OR⁶ or R³R⁴C═CR⁵R⁶;
Y′ is a second non-dissociating monomer of formula R³R⁴C═CR⁵—CO—OR⁶ or R³R⁴C═CR⁶R⁶;
Z′ is a dissociating monomer of formula R³R⁴C═CR⁵—CO₂H or formula R³R⁴C═CR⁵—CO—O—(CH₂)ₙ—CO₂H;
R³, R⁴ and R⁵ are each independently hydrogen or an inert aliphatic or aromatic organic moiety;
R⁶ is an inert aliphatic or aromatic organic moiety;
x is an integer from 30 to 90;
y is an integer from 0 to 50;
z is an integer from 10 to 60;
wherein x, y and z represent the % molar composition of components X, Y and Z respectively and the sum of x+y+z=100%.

Suitable inert aliphatic and aromatic organic moieties include unsubstituted or substituted C₁ to C₅₀ alkyl or C₆ to C₁₀ aryl moieties, more preferably C₁ to C₂₀ alkyl or C₆ to C₈ aryl moieties. When substituted, the moieties are preferably substituted with a C₁ to C₁₀ linear or branched alkyl group, preferably a C₁ to C₆ linear or branched alkyl group, or a C₆ to C₁₀ aryl group.

In a particularly preferred embodiment of the invention, X′ and/or Y′ are R³R⁴C═CR⁵R⁶, wherein R³, R⁴ and R⁵ are H and R⁶ is unsubstituted C₆-aryl or a C₆-aryl substituted with a C₁ to C₆ linear or branched alkyl-group. Preferably, only one of X′ or Y′ has the formula R³R⁴C═CR⁵R⁶, and the other has the formula R³R⁴C═CR⁵—CO—OR⁶.

Examples of useful dissociating monomers, Z′, include, but are not limited to, acrylic acid (AA), methacrylic acid (MAA) and β-carboxyethyl acrylate (BCEA).

Preferably, the bulk of the pH responsive, vinylic copolymer (e.g. up to 80%) comprises non-dissociating monomers (such as BMA, EHA, STY, MMA) with the balance (e.g. up to 20%) comprising dissociating monomers (such as AA, MAA, BCEA). The non-dissociating monomers provide the essential chemical resistance and barrier characteristics, whereas the dissociating monomers give the necessary pH switch to insolubility/solubility.

In one preferred embodiment, the pH responsive, vinylic copolymer comprises from about 50 to about 95 weight % of non-dissociating monomers (such as BMA, EHA, STY, MMA), preferably from about 60 to about 90 weight %, more preferably from about 80 to about 88 weight %.

Preferably, the pH responsive, vinylic copolymer comprises from about 5 to about 50 weight % of dissociating monomers (such as AA, MAA, BCEA), preferably from about 10 to about 40 weight %, more preferably from about 12 to about 20 weight %.

The characteristics of the pH responsive, vinylic copolymer coating may be controlled by careful selection of the most appropriate non-dissociating monomers to maximise the barrier properties of the copolymer coating towards neutral and acidic media, whilst not impairing the ability of the coating to release the active agent-containing core under alkaline conditions. This is achieved by balancing the choice and proportion of hydrophilic and hydrophobic non-dissociating comonomers employed in the synthesis of the coating copolymer.

As used herein the term “hydrophobic” means a component which lacks affinity for water; i.e. a component that tends to repel and not absorb water. Components of this type are typically non polar.

As used herein the term “hydrophilic” means a component which has a strong affinity for water; i.e. a component that tends to dissolve in, mix with, or be wetted by water. Components of this type are typically polar or charge-polarized and capable of hydrogen bonding.

Examples of preferred hydrophilic non-dissociating comonomers include MMA, MA, EA and EMA.

Examples of preferred hydrophobic non-dissociating comonomers include STY, EHA and BMA.

In another preferred embodiment of the invention, the pH responsive, vinylic copolymer is formed from monomers selected from methyl methacrylate (MMA), styrene (STY), ethyl methacrylate (EMA), butyl methacrylate (BMA), iso-butyl methacrylate (iBMA), methyl acrylate (MA), butyl acrylate (BA), 2-ethylhexyl acrylate (EHA), acrylic acid (AA), methacrylic acid (MAA) and β-carboxyethylacrylate (BCEA). More preferably, the pH responsive, vinylic copolymer is formed from a mixture of monomers selected from:
1. BMA, EHA and MAA or AA;
2. BMA, EHA and AA or MAA;
3. BMA, EHA and BCEA;
4. BMA, MMA and AA or MAA;
5. BA, MMA and AA or MAA;
6. EMA, EHA and MAA or AA;
7. EMA, BA and MAA or AA;
8. iBMA, EHA and MAA or AA; and
9. STY, EHA and MAA or AA.

More preferably, the pH responsive, vinylic copolymer is formed from a mixture of monomers selected from:
1. EMA, EHA and MAA;
2. BMA, BA and MAA;
3. BMA, i-BMA and MAA;
4. BMA, EHA and MAA;
5. i-BMA, EHA and MAA;
6. STY, EHA and MAA; and
7. BA, MMA and MAA.

In one preferred embodiment of the invention, the pH responsive, vinylic copolymer is formed from a mixture of from about 45 to about 90 weight % EMA, from about 10 to about 50 weight % EHA or BA and from about 8 to about 40 weight % MAA or AA, preferably from about 50 to about 85 weight % EMA, from about 1.0 to about 45 weight % EHA or BA and from about 10 to about 30 weight % MAA or AA, more preferably from about 55 to about 80 weight % EMA, from about 10 to about 35 weight % EHA or BA and from about 6 to about 20 weight % MAA or AA.

In another preferred embodiment of the invention, the pH responsive, vinylic copolymer is formed from a mixture of from about 55 to about 95 weight % BMA, from about 1 to about 20 weight % EHA and from about 5 to about 25 weight % MAA or AA, preferably from about 60 to about 90 weight % BMA, from about 1 to about 15 weight % EHA and from about 5 to about 25 weight % MAA or AA, more preferably from about 70 to about 85 weight % BMA, from about 5 to about 13 weight % EHA and from about 5 to about 25 weight % MAA or AA.

In a further preferred embodiment of the invention, the pH responsive, vinylic copolymer formed from a mixture of from about 20 to about 80 weight % STY, from about 20 to about 60 weight % EHA and from about 1 to about 35 weight % MAA or AA, preferably, 25 to about 65 weight % STY, from about 25 to about 50 weight % EHA and from about 5 to about 25 weight % MAA or AA.

In a further preferred embodiment of the invention, the pH responsive, vinylic copolymer is formed from a mixture of from about 60 to about 80 weight % MMA, from about 10 to about 30 weight % BA and from about 1 to about 25 weight % AA or MAA, preferably, 65 to about 75 weight % MMA, from about 15 to about 35 weight % BA and from about 5 to about 20 weight % AA or MAA.

In a further preferred embodiment of the invention, the pH responsive, vinylic copolymer is formed from a mixture of from about 60 to about 80 weight % BMA, from about 10 to about 30 weight % MMA and from about 1 to about 25 weight % AA or MAA, preferably, 65 to about 75 weight % BMA, from about 15 to about 35 weight % MMA and from about 5 to about 20 weight % AA or MAA.

In a further preferred embodiment of the invention, the pH responsive, vinylic copolymer is formed from a mixture of from about 35 to about 75 weight % BMA, from about 20 to about 50 weight % EHA and from about 5 to about 20 weight % MAA, preferably, about 40 to about 65 weight % BMA, from about 25 to about 40 weight % EHA and from about 10 to about 15 weight % MAA.

In a further preferred embodiment of the invention, the pH responsive, vinylic copolymer is formed from a mixture of from about 50 to about 90 weight % BMA, from about 10 to about 30 weight % BA or i-BMA and from about 5 to about 30 weight % MAA, preferably, about 60 to about 80 weight % BMA, from about 10 to about 20 weight % BA or i-BMA and from about 5 to about 15 weight % MAA.

In a further preferred embodiment of the invention, the pH responsive, vinylic copolymer is formed from a mixture of from about 40 to about 90 weight % i-BMA, from about 10 to about 50 weight % EHA and from about 5 to about 30 weight % MAA, preferably, about 45 to about 75 weight % i-BMA, from about 15 to about 40 weight % EHA and from about 5 to about 20 weight % MAA.

In a further preferred embodiment of the invention, the pH responsive, vinylic copolymer is formed from a mixture of from about 10 to about 50 weight % BA, from about 40 to about 80 weight % MMA and from about 1 to about 20 weight % MAA, preferably, about 20 to about 35 weight % BA, from about 50 to about 60 weight % MMA and from about 5 to about 15 weight % MAA.

In one preferred embodiment of the invention, the pH responsive, vinylic copolymer coating comprises a mixture of two or more acrylic copolymers as described herein.

In one highly preferred embodiment, the pH responsive, vinylic copolymer is selected from the following:

### NeoCryl® BT-26, NeoCryl® BT-27 and NeoCryl® BT-36 (DSM NeoResins, Waalwijk, The Netherlands);

Example 1, a copolymer of EMA (55.7%), EHA (37.7%) and MAA (6.6%);
Example 2, a copolymer of EMA (80.0%), EHA (13.4%), and MAA (6.6%);
Example 3, a copolymer of EMA (77.0%), EHA (16.4%), and MAA (6.6%);
Example 4, a copolymer of BMA (77.7%), BA (15.7%), and MAA (6.6%);
Example 5, a copolymer of BMA (76.2%), i-BMA (17.5%), and MAA (6.3%);
Example 6, a copolymer of BMA (61.0%), EHA (27.0%), and MAA (12.0%);
Example 7, a copolymer of i-BMA (50.0%), EHA (36.5%), and MAA (13.5%);
Example 8, a copolymer of i-BMA (47.5%), EHA (37.5%), and MAA (15.0%);
Example 9, a copolymer of STY (40.0%), EHA (45.0%), and MAA (15.0%);
Example 10, a copolymer of STY (40.0%), EHA (42.5%), and MAA (17.5%);
Example 11, a copolymer of STY (35.0%), EHA (47.5%), and MAA (17.5%);
Example 12, a copolymer of STY (40.0%), EHA (40.0%), and MAA (20.0%);
Example 13, a copolymer of BMA (47.5.0%), EHA (37.5%), and MAA (15.0%);
Example 14, a copolymer of BMA (65.0%), EHA (20.0%), and MAA (15.0%);
Example 15, a copolymer of BA (30.0%), MMA (60.0%), and MAA (10.0%);
Example 16, a copolymer of i-BMA (74.0%), EHA (17.0%), and MAA (9.0%); and
Example 17, a copolymer of STY (52.0%), EHA (40.0%), and MAA (8.0%).

The alkali soluble polymers of the invention are conveniently produced from a wide range of starting monomers by a number of synthetic routes including bulk, solution, suspension and emulsion polymerisation. The polymers are most conveniently produced by emulsion polymerisation.

The choice and quantity of the monomers employed will determine the characteristics of the polymer; hydrophilic/hydrophobic balance, softness/hardness, glass transition temperature (T_{g}) and solution characteristics. Particularly preferred monomers are selected from, but not limited to, methyl methacrylate (MMA), ethyl methacrylate (EMA), butyl methacrylate (BMA), iso-butyl methacrylate (iBMA), 2-ethylhexyl methacrylate (EHMA), iso-bornyl methacrylate (iBoMA), methyl acrylate (MA), ethyl acrylate (EA), butyl acrylate (BA), 2-ethylhexyl acrylate (EHA), styrene (STY), acrylic acid (AA), methacrylic acid (MAA) and sodium acrylate (SAA), where, for example, acrylic acid (AA) would be considered a hydrophilic monomer, whereas 2-ethylhexyl acrylate would be considered to be a hydrophobic monomer, and where butyl acrylate (BA) would be a soft monomer, but styrene (STY) a hard monomer. When selecting the monomers for the execution of a polymer synthesis, the reactivity ratio of the monomer combinations must also be taken into account to ensure that the desired distribution of monomers is achieved whether that is a block or random distribution.

Such polymers may be tailored to give a desirable balance of properties including controlled solubility as a function of pH, with insolubility observed at acidic and neutral pH values (below their pKₐ values) and solubility at basic pH values (above their pKₐ values). Ideally, the polymers give tough, non-tacky, flexible dry films that demonstrate good adhesion to the core material and facilitate the preparation of a free flowing coated product robust to brittle fracture and coating failure, whilst demonstrating low water uptake from acidic aqueous media and good barrier properties.

Such emulsion vinylic polymers are commercially available from various suppliers including, for example, DSM NeoResins (Waalwijk, The Netherlands). The behaviour of several commercially available alkali soluble vinylic copolymers and mixtures thereof, has been explored; for example, NeoCryl® BT-26 (T_{g}=34° C.), NeoCryl® BT-27 (T_{g}=16° C.) and NeoCryl® BT-36 (T_{g}=61° C.). Thus, in one preferred embodiment, the vinylic copolymer is a NeoCryl® alkaline soluble acrylic copolymer emulsion.

Emulsion polymerisation may be conducted at temperatures from about 20° C. to about 95° C. Preferably, emulsion polymerisation is conducted at a temperature of at least about 70° C., more preferably from about 75° C. to about 85° C.

Preferably, the monomers are selected from methyl methacrylate (MMA), ethyl methacrylate (EMA), butyl methacrylate (BMA), iso-butyl methacrylate (iBMA), methyl acrylate (MA), butyl acrylate (BA), 2-ethylhexyl acrylate (EHA), styrene (STY), acrylic acid (AA), methacrylic acid (MAA) and β-carboxyethylacrylate (BCEA).

The system is preferably stabilised with anionic surfactants including, but not limited to, sodium lauryl sulphate (SLS), sodium benzene alkyl sulphonate (SBAS) and sodium dioctylsulfosuccinate (SDSS).

The polymerisation is preferably initiated using a free radical initiator. Suitable initiators include, but are not limited to, persulphates, percarbonates, inorganic peroxides, organic peroxides (such as dialkyl peroxides, acyl peroxides, alkyl hydroperoxides, peroxy esters), hydroperoxides, azo compounds and cobalt complexes. More preferred initiators include potassium persulphate, ammonium persulphate, sodium persulphate, hydrogen peroxide, benzoyl peroxide, cumene hydroperoxide, t-butyl hydroperoxide, di-t-butyl peroxide, t-butyl perbenzoate, azoisobutyronitrile, cobalt II and cobalt II complexes of porphyrins, dioximes and benzildioxime diboron compounds. Other suitable initiators include azo-isobutyronitrile, dimethyl 2,2′-azo bis-isobutylate, hydrogen peroxide and benzoyl peroxide.

Chain transfer agents (CTA) are typically employed to control molecular weight. Suitable chain transfer agents include, but are not limited to, mercaptans, for example, methyl-3-mercapto propionate (MMP), lauryl mercaptan (LM) or primary octyl mercaptan (POM).

A further aspect of the invention relates to a process for preparing a composite as defined above, said process comprising applying a pH responsive, vinylic copolymer coating to the surface of one or more core units comprising an active agent.

In one preferred embodiment of the invention, the core units are prepared by co-agglomerating a granulating or binding agent with the active agent(s) prior to coating the core units with the pH responsive, vinylic copolymer.

Encapsulation may be carried out by any suitable means and the method is not critical to the invention.

For example, the coating material may be sprayed on as a molten material or as a solution, latex or dispersion in a solvent/carrier liquid which is subsequently removed by evaporation. The coating material can also be applied as a powder coating e.g. by electrostatic techniques.

Molten coating is a preferred technique for coating materials of melting point <80° C. but is less convenient for higher melting points (i. e. >100° C.). For coating materials of melting point >80° C., spraying on as a solution, latex or dispersion are preferred. Organic solvents such as ethyl and isopropyl alcohol can be used to form the solutions or dispersions, although this will necessitate a solvent recovery stage in order to make their use economic. However, the use of organic solvents also gives rise to safety problems such as flammability and operator safety and thus aqueous solutions, latex or dispersions are preferred.

Aqueous solutions are advantageous as the coating materials herein have a high aqueous solubility, provided the solution has a sufficiently low viscosity to enable it to be handled. Preferably a concentration of from about 5% to about 50% and preferably from about 10% to about 25% by weight of the coating material in the water or solvent is used in order to reduce the drying/evaporation load after surface treatment has taken place. The treatment apparatus can be any of those normally used for this purpose, such as inclined rotary pans, rotary drums and fluidised beds.

In a preferred embodiment of the invention, the coating is applied to the cores either by fluid bed coating or fluid bed drying. The polymer is preferably applied to the core units as an alkaline coating solution or as an acidic latex. In the embodiment where the polymer is applied as an alkaline coating solution, preferably the solution further comprises a stabilizer, for example, ammonia. Aqueous alkaline solutions of the polymer are prepared by neutralisation of the acidic latex. Neutralisation with volatile amines, such as ammonia, trimethyl amine, triethyl amine, ethanolamine and dimethylethanolamine, is preferred as the volatile component is readily lost and a robust polymer coating is readily achieved. Typically neutralisation is accompanied by clarification of the coating mixture, from an opaque latex to a clear or hazy solution, and an increase in viscosity. Additional solvent or water may be added to reduce the polymer concentration and solution viscosity and so obtain a solution suitable for further processing.

In fluid bed coating the particulate core material may be fluidised in a flow of hot air and the coating solution or latex sprayed onto the particles and dried, where the coating solution or latex may be applied by top spray coating, bottom spray (Wurster) coating or tangential spray coating, where bottom spray (Wurster) coating is particularly effective in achieving a complete encapsulation of the core. In general, a small spray droplet size and a low viscosity spray medium promote uniform distribution of the coating over the particles.

In fluid bed drying the particulate core material is mixed with the coating solution or latex and the resulting moist product introduced to the fluid bed dryer, where it is held in suspension in a flow of hot air, where it is dried. Such systems are available from several suppliers including GEA Process Engineering (Bochum, Germany) and Glatt Process Technology (Binzen, Germany).

According to a further aspect of the present invention, there is provided a composition comprising, a composite comprising one or more core units, each core unit comprising an active agent and having a pH responsive, vinylic copolymer coating, and one or more active and/or non-active agents. Such compositions may be in solid or liquid form. In solid form, the compositions may be powders or tablets. The composites may themselves be incorporated into other solid compositions such as tablets, extrudates and agglomerates. The composites can also be suspended in aqueous and non-aqueous liquid compositions in which the pH responsive, vinylic copolymer coating is insoluble and inert.

The composites of the invention and formulations thereof may be used in a wide variety of applications including laundry detergents, cleaning compositions and additives, autodishwashing detergents, cleaning compositions and additives, dental care compositions, hair treatments, compositions used in the agricultural industry, compositions used in the paper and paper waste industry and compositions used in cosmetics.

In a preferred embodiment of the invention the composite or a formulation thereof comprises a bleaching agent, in particular a peroxy acid, and/or an enzyme. Such composites and formulations thereof may be used in laundry detergents and cleaning compositions, auto-dishwashing detergents and cleaning compositions, dental care compositions, hair dyeing, decolourising and bleaching compositions, industrial decolourising and bleaching compositions, and compositions used in the processing and treatment of textiles, textile waste, paper and paper waste.

In a further preferred embodiment of the invention, there is provided a composite comprising one or more core units, each core unit comprising an active agent and having a pH responsive, vinylic copolymer coating, or a formulation comprising the same, for use as a cleaner. Preferred cleaners include hard surface, dishwasher and laundry cleaners.

One preferred application for the composites of the invention is as components of liquid anhydrous liquid detergent compositions, which are added to dish washing and washing machines as a unit dose product (supplied as a liquid filled pouch) or by means of a dosing device.

One preferred application for the composites of this invention is as components of low water content (5 to 25%) liquid detergent compositions, which are added to dish washing and washing machines as a unit dose product (supplied as a liquid filled pouch) or by means of a dosing device.

One preferred application for the composites of this invention is as components of medium water content (25 to 60%) liquid detergent compositions, which are introduced to the dish washing and washing machines by means of a dosing device or as a bulk liquid.

One preferred application for the composites of this invention is as components of high water content (60 to 95%) liquid detergent compositions, which are introduced to the dish washing and washing machines by means of a dosing device or as a bulk liquid.

One preferred embodiment relates to a liquid dishwash product comprising the composite of the invention. Preferably, the dishwash product is an acidic or neutral liquid dishwash product, more preferably, an acidic liquid dishwash product.

In one preferred embodiment of the invention, there is provided a solid or liquid auto-dishwasher product, preferably for industrial or commercial use, which comprises a composite of the invention.

In a particularly preferred embodiment of the invention, there is provided a solid or liquid auto-dishwasher product comprising from about 0.5% to about 25% by weight of a composite of the invention. Preferably, said product comprises an active agent selected from a bleaching agent, an enzyme, or a mixture thereof.

In one preferred embodiment, the dishwash product is a detergent composition, more preferably still, a liquid detergent composition. Typically, the liquid detergent composition will include water (from 0% to 95%).

In one preferred embodiment, the invention relates to a solid or liquid laundry product comprising a composite as described above.

In one particularly preferred embodiment, the invention relates to a solid or liquid laundry product comprising from about 0.5% to about 25% by weight of a composite as described above.

Another preferred embodiment relates to a liquid laundry product comprising the composite of the invention. Preferably, the laundry product is an acidic or neutral liquid laundry product, more preferably, an acidic liquid laundry product.

In another preferred embodiment of the invention, there is provided a solid or liquid laundry product comprising from about 0.5% to about 25% by weight of a composite of the invention. Preferably, said product comprises an active agent selected from a bleaching agent, enzyme, fragrance or perfume, or a mixture thereof.

In one preferred embodiment of the invention, the laundry product is a detergent composition, more preferably still, a liquid detergent composition. Typically, the liquid detergent composition will include water (from 0% to 95%).

In another preferred embodiment of the invention, the dishwash product is a powdered or tableted dishwash product, more preferably, a powdered or tableted detergent composition.

In another preferred embodiment of the invention, the laundry product is a powdered or tableted laundry product, more preferably, a powdered or tableted detergent composition.

Detergent compositions will typically contain from about 0.5% to about 25.0% of the composite of the invention, more preferably from about 1.0% to about 12.5% and even more preferably from about 1.0% to about 10.0% by weight of the total composition.

In one preferred embodiment of the invention, the dishwash product further comprises one or more of an anionic surfactant, a non-ionic surfactant and a cationic surfactant.

In a further preferred embodiment of the invention, the laundry product further comprises one or more of an anionic surfactant, a non-ionic surfactant and a cationic surfactant.

Typically, alcohol alkoxylate non-ionic surfactants are preferably present in an amount of from about 1% to about 60% by weight of the composition, more preferably from about 5% to about 50%, even more preferably from about 5% to about 30%.

Detergent compositions of the present invention may also optionally include anti-redeposition and soil suspension agents, foam control agents, thickeners, perfumes and colours, as well as other ingredients known to be useful in dishwash and laundry detergents.

The present invention is further illustrated with reference to the following figures, wherein:

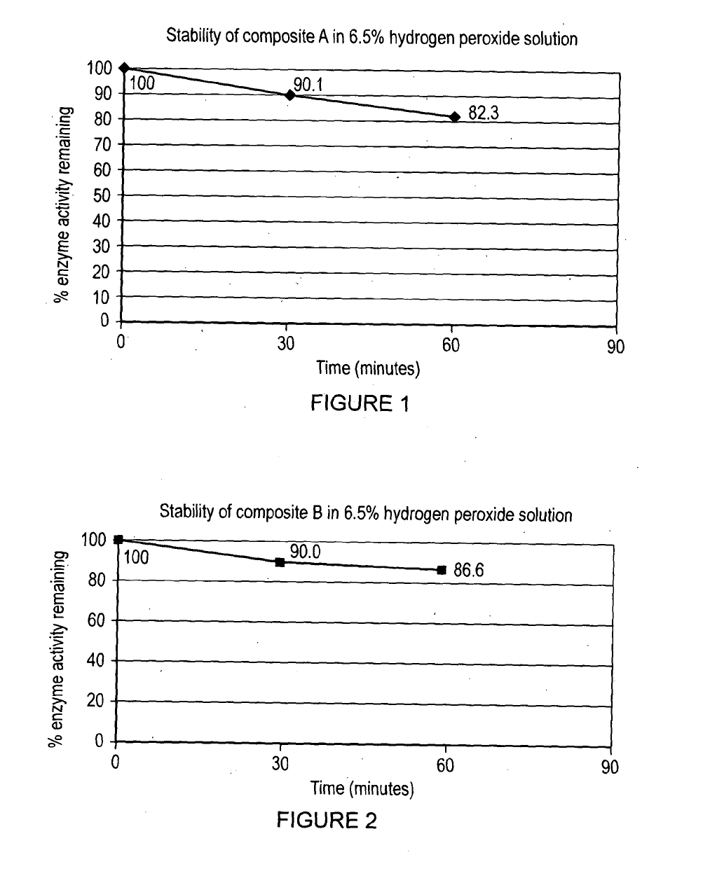

FIG. 1 shows the stability of composite A in 6.5% hydrogen peroxide solution (% enzyme activity remaining versus time). Composite A is Stainzyme coated with a copolymer of BMA (47.5.0%), EHA (37.5%), and MAA (15.0%) (polymeric material according to Example 13).

FIG. 2 shows the stability of composite B in 6.5% hydrogen peroxide solution (% enzyme activity remaining versus time). Composite B is Stainzyme coated with a copolymer of BMA (47.5.0%), EHA (37.5%), and MAA (15.0%) (polymeric material according to Example 13).

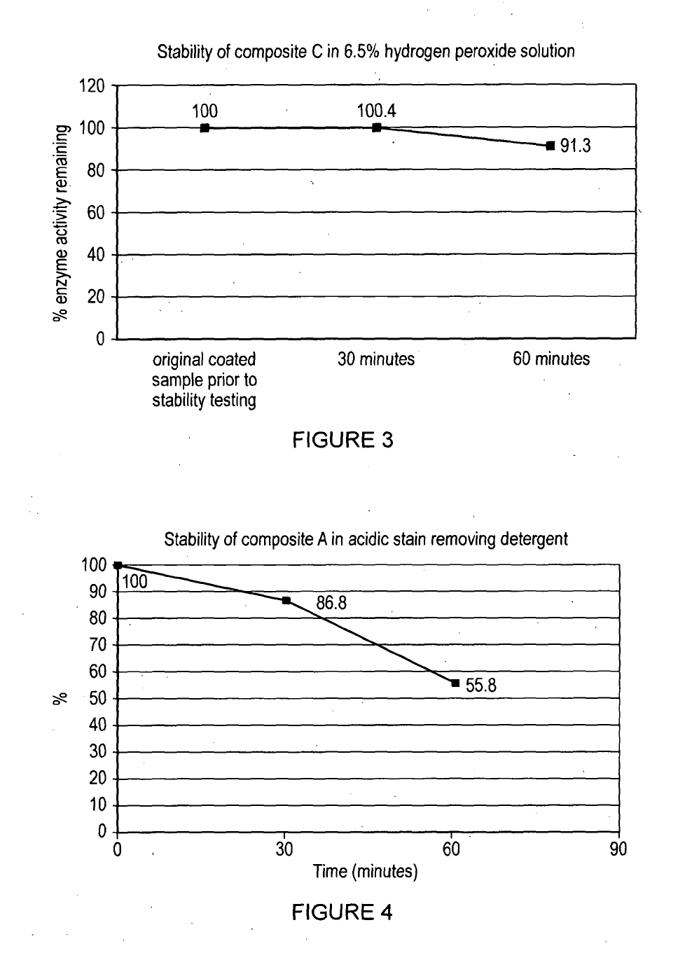

FIG. 3 shows the stability of composite C in 6.5% hydrogen peroxide solution (% enzyme activity remaining versus time). Composite C is Stainzyme coated with a copolymer of i-BMA (74.0%), EHA (17.0%), and MAA (9.0%) (polymeric material according to Example 16).

FIG. 4 shows the stability of composite A in acidic stain removing detergent (% enzyme activity remaining versus time). Composite A is as defined above.

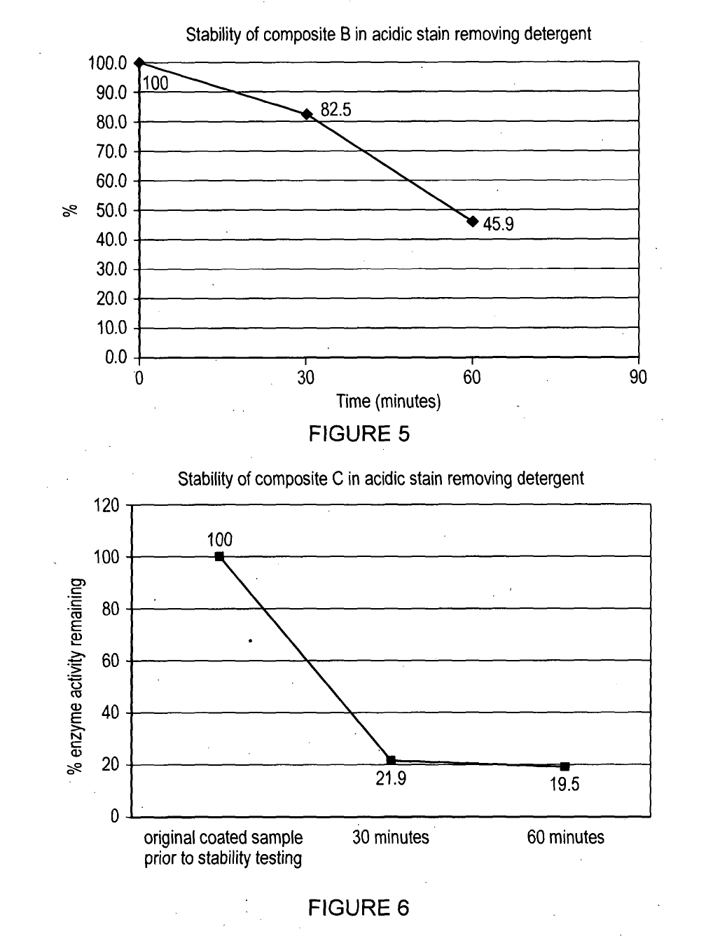

FIG. 5 shows the stability of composite B in acidic stain removing detergent (% enzyme activity remaining versus time). Composite B is as defined above.

FIG. 6 shows the stability of composite C in acidic stain removing detergent (% enzyme activity remaining versus time). Composite C is as defined above.

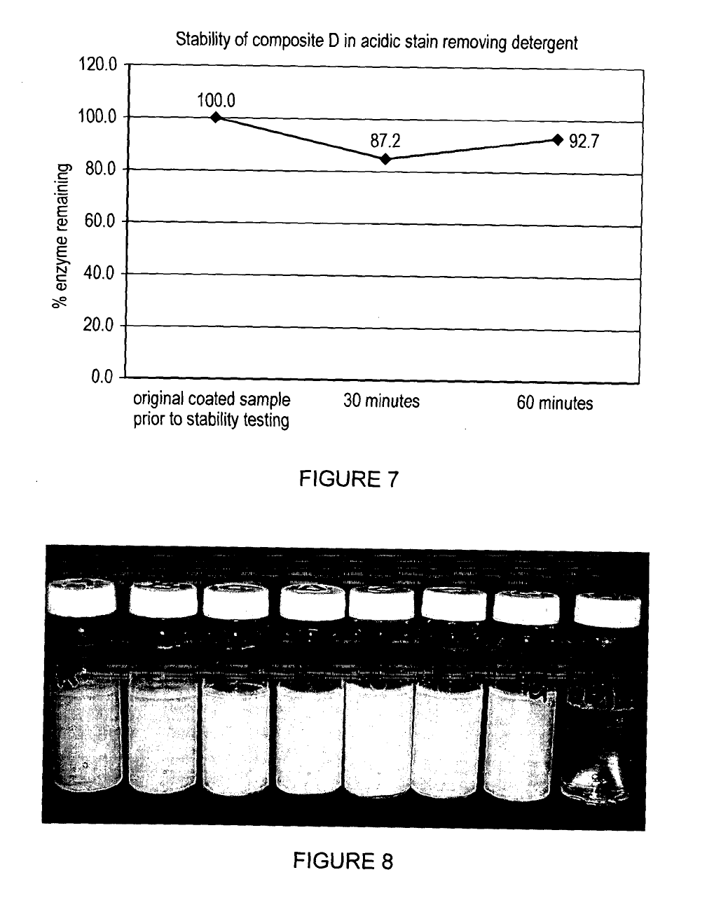

FIG. 7 shows the stability of composite D in acidic stain removing detergent (% enzyme activity remaining versus time). Composite D is Stainzyme coated with a copolymer of STY (52.0%), EHA (40.0%), and MAA (8.0%) (polymeric material according to Example 17).

FIG. 8 shows the solution characteristics of NeoCryl® BT-26. The sample pH increases from left to right in the pictured samples. At the lowest pH the product is observed as an opaque latex (i.e. the polymer is insoluble) whilst at the highest pH it is a clear solution (i.e. the polymer is soluble).

The present invention is further described by the following non-limiting examples.

### EXAMPLES

In the examples below, reference is made to the following polymeric materials:

### NeoCryl® BT-26, NeoCryl® BT-27 and NeoCryl® BT-36 (DSM NeoResins, Waalwijk, The Netherlands);

Example 1 is a copolymer of EMA (55.7%), EHA (37.7%) and MAA (6.6%);
Example 2 is a copolymer of EMA (80.0%), EHA (13.4%), and MAA (6.6%);
Example 3 is a copolymer of EMA (77.0%), EHA (16.4%), and MAA (6.6%);
Example 4 is a copolymer of BMA (77.7%), BA (15.7%), and MAA (6.6%);
Example 5 is a copolymer of BMA (76.2%), i-BMA (17.5%), and MAA (6.3%);
Example 6 is a copolymer of BMA (61.0%), EHA (27.0%), and MAA (12.0%);
Example 7 is a copolymer of i-BMA (50.0%), EHA (36.5%), and MAA (13.5%);
Example 8 is a copolymer of i-BMA (47.5%), EHA (37.5%), and MAA (15.0%);
Example 9 is a copolymer of STY (40.0%), EHA (45.0%), and MAA (15.0%);
Example 10 is a copolymer of STY (40.0%), EHA (42.5%), and MAA (17.5%);
Example 11 is a copolymer of STY (35.0%), EHA (47.5%), and MAA (17.5%);
Example 12 is a copolymer of STY (40.0%), EHA (40.0%), and MAA (20.0%);
Example 13 is a copolymer of BMA (47.5.0%), EHA (37.5%), and MAA (15.0%);
Example 14 is a copolymer of BMA (65.0%), EHA (20.0%), and MAA (15.0%);
Example 15 is a copolymer of BA (30.0%), MMA (60.0%), and MAA (10.0%);
Example 16 is a copolymer of i-BMA (74.0%), EHA (17.0%), and MAA (9.0%);
Example 17 is a copolymer of STY (52.0%), EHA (40.0%), and MAA (8.0%).
AA (acrylic acid) was obtained from Sigma Aldrich (Gillingham, UK);
MMA (methylmethacrylate) was obtained from Sigma Aldrich (Gillingham, UK);
STY (styrene) was obtained from Sigma Aldrich (Gillingham, UK);
EMA (ethylmethacrylate) was obtained from Sigma Aldrich (Gillingham, UK);
EHA (2-ethylhexylacrylate) was obtained from Sigma Aldrich (Gillingham, UK);
MAA (methacrylic acid) was obtained from Sigma Aldrich (Gillingham, UK);
BA (butylacrylate) was obtained from Sigma Aldrich (Gillingham, UK);
BMA (butylmethacrylate) was obtained from Sigma Aldrich (Gillingham, UK);
i-BMA (iso-butylmethacrylate) was obtained from Sigma Aldrich (Gillingham, UK);
Mykon ATC was obtained from Warwick International Group (Mostyn, UK).

### Synthesis of an Alkali Soluble Vinylic Copolymer

The pH responsive, vinylic copolymer may be conveniently synthesised by a number of techniques. Preferred methods include emulsion and suspension polymerisation which were performed as follows:

### (1) Emulsion Polymerisation

1. Into a clean, dry, closed jacketed glass vessel charge the bulk of the required water and anionic surfactant.
2. The vessel was fitted with an overhead stirrer, an equalising pressure dropping funnel, a condenser and a thermocouple.
3. The vessel was stirred continuously under a nitrogen blanket and thermostated at 75° C.
4. Separately the required monomers were mixed together and placed in the equalising pressure dropping funnel.
5. Separately a water soluble free radical initiator was dissolved in the balance of the water and added to the stirred glass vessel and the temperature of the bulk aqueous surfactant solution allowed to return to 75° C.
6. After a further 20 minutes the addition of the monomer solution was initiated.
7. The monomer solution was drip fed into the glass vessel over a three hour period.
8. On completion of the monomer addition the stirred vessel was maintained at the set temperature for a further hour.
9. The product was then allowed to cool to ambient and filtered through a 72 μm cloth prior to characterisation and evaluation.
10. The weight percent polymer, particle size distribution and minimum film forming temperature of the resulting latex and the glass transition temperature of the isolated polymer were determined.

### (2) Suspension Polymerisation

The pH responsive, vinylic copolymer may also be prepared by an aqueous suspension polymerisation, for example as described in Journal of Applied Polymer Science, 1982, 27, 133-138. The desired mixture of monomers is prepared and suspended, as droplets typically of diameter from 1 μm to 1000 μm, in the water. Preferably stabilisers are added to prevent agglomeration of the droplets. Examples of stabilisers which may be added include polyvinyl alcohol, polyacrylic acid, polyvinyl pyrrolidone, polyalkylene oxide, barium sulphate, magnesium sulphate and sodium sulphate. Agitation of the suspension is preferably employed. The method of agitation employed may help to assist in maintaining the suspension. A free radical initiator commonly serves to initiate polymerisation. The free radical initiator employed is selected according to the types of monomers present. Examples of free radical initiators which may be used to prepare the alkali soluble polymers of the present invention include benzoyl peroxide, dioctanoyl peroxide, 2,2′-azo-bis-isobutyronitrile and 2,2′-azobis(2,4-dimethylvaleronitrile). The selection of a suitable temperature range may be influenced by the nature of the monomers and the initiator present. The polymerisation of the monomers is commonly carried out at solution temperatures ranging from about 15° C. to about 160° C., preferably from about 50° C. to about 90° C. The polymer beads may be isolated by filtration and optionally washed with water or solvents. The polymer beads may be dissolved in aqueous solution by the use of a neutralising amine such as ammonia, triethyl amine or ethanol amine.

### Physical Characteristics of Solid Polymer Sections of NeoCryl® BT-26 and BT-27

Solid polymer sections were prepared by casting and drying with sections of each product and mixtures of the products considered. The surface tack and malleability of these dry sections was assessed under ambient laboratory conditions; surface tack as non-tacky or tacky, malleability as soft, pliable, semi-brittle or brittle. The results obtained are presented in the table below.

| Polymer Composition | | | |
|---|---|---|---|
| (Parts by Weight) | | | |
| NeoCryl ® BT-26 | NeoCryl ® BT-27 | | |
| (Tg = 34° C.) | (Tg = 1° C.) | Surface Tack | Malleability |
| 100 | 0 | Non-Tacky | Semi-Brittle |
| 70 | 30 | Non-Tacky | Pliable |
| 50 | 50 | Non-Tacky | Pliable |
| 0 | 100 | Non-Tacky | Soft |

Non-tacky, pliable polymer sections were produced. Such physical characteristics are extremely desirable for the robust and tough coating of an active-containing core unit.

Water Uptake by Solid Polymer Sections from Acidic Aqueous Media

Solid polymer sections were prepared by casting and drying. The sections were then immersed in acidic aqueous media (25° C./7 days). Their weight was found to increase, consistent with their low acid solubility, due to the uptake of a small amount of water from the media and described by the increase in weight (expressed as a percentage of the original section weight). The results obtained are presented in the table below.

| | Water Uptake (%) | |
|---|---|---|
| Polymer | Aqueous Medium pH 3 | Aqueous Medium pH 6 |
| NeoCryl ® BT-26 | 12.0 | 10.0 |
| NeoCryl ® BT-27 | 12.0 | 13.0 |
| NeoCryl ® BT-36 | 5.0 | 6.0 |
| Example 1 | 15.0 | 17.0 |
| Example 2 | 14.0 | n/a |
| Example 3 | 14.0 | n/a |

Polymer sections demonstrating low acid solubility and low water uptake were produced.

### Solution Characteristics of Alkali Soluble Vinylic Copolymers

The solution characteristics of the pH responsive, vinylic copolymer are critical to the effective protection and release of the active-containing core unit. The solution characteristics of NeoCryl® BT-26 are typical of such materials. Under acid conditions the product is observed as a latex demonstrating a characteristic monomodal particle size distribution with an average hydrodynamic diameter (by photon correlation spectroscopy) of 91.0 nM at pH 3.4. When the pH of the latex is raised to values close to the pKₐ of the polymer, the polymer becomes progressively more hydrophilic and the droplets swell due to the penetration of water (with an average hydrodynamic diameter by photon correlation spectroscopy of 97.5 nanometers at pH 4.4), but remain largely intact. Finally when the pH is raised to an alkaline value (pH>8.0) the acid-base equilibrium of the carboxylic is shifted to the base (—CO₂⁻) and the polymer becomes fully water soluble; the product is observed to converted from a milky latex to a clear homogeneous viscous solution as evidenced in the photograph shown in FIG. 8. The sample pH increases from left to right in the pictured samples. At the lowest pH the product is observed as an opaque latex (i.e. the polymer is insoluble) whilst at the highest pH it is a clear solution (i.e. the polymer is soluble).

### pKa of pH Responsive, Vinylic Copolymers

A series of pH responsive, vinylic copolymers were synthesised to provide materials with a wide range of desirable pKₐ values, as detailed in the table below.

| Polymer | pKₐ |
|---|---|
| Example 4 | 7.5 |
| Example 5 | 8.0 |
| Example 6 | 8.5 |

### pH Responsiveness of Vinylic Copolymers

A common characteristic for this kind of polymer is the relationship between solution viscosity of the polymer and pH. Alkali soluble copolymers are typically made as aqueous latex emulsions under acidic conditions where the polymer is hydrophobic, essentially insoluble and has a tight, coil like structure. On addition of alkali to the latex the polymer switches from being essentially hydrophobic to hydrophilic as the acid functional groups dissociate the polymer chains extend and uncoil leading to an increase in viscosity as the polymer dissolves or becomes water swollen. Therefore, a simple measurement of viscosity response to increase in pH will provide a useful indication of the responsiveness of that polymer as a coating to pH change. The bigger the differences between viscosity at low and high pH, the more soluble the polymer becomes.

### Examples of Viscosity Changes Under Different pH

| | |
|---|---|
| Polymer | Viscosity (mPa · s) |

| reference | pH 4 | pH 5 | pH 8 | pH 9 |
|---|---|---|---|---|
| Example 7 | 1.86 | 1.77 | 2.76 | 8.97 |
| Example 8 | 1.89 | 1.90 | 4.23 | 20.20 |
| Example 9 | 1.95 | 1.98 | 2.4 | 3.6 |
| Example 10 | 1.92 | 1.95 | 2.7 | 5.58 |
| Example 11 | 1.99 | 2.08 | 3.33 | 8.73 |
| Example 12 | 1.98 | 2.02 | 3.21 | 9.39 |
| Example 13 | 1.84 | 1.87 | 4.96 | 27.10 |
| Example 14 | 1.98 | 1.8 | 3.01 | 17.3 |
| Example 15 | 1.75 | 1.77 | 2.46 | 21.90 |

### Spray Coating Procedure

Various modifications of pH responsive, vinylic copolymers were spray coated from neutralised latex emulsion onto Stainzyme® (amylase). The spray coating process was performed using a Mini Glatt fluid bed system (from Glatt, Binzen, Germany), which permitted the evaluation and optimisation of process conditions at the laboratory scale. Optimum results, with respect to coating quality, were achieved by bottom spray (Wurster) coating combined with careful control of the following parameters:
1. Polymer solids of the coating mixture: preferred 5-10%.
2. Addition time: 1-10 hrs, preferred 2 hrs.
3. Bed pressure during addition: 0.3-0.8 bar.
4. Jet pressure during addition: 0.4-0.5 bar.
5. Bed temperature during addition: 30-70° C.
6. Annealing conditions: bed pressure (0.6-1.0 bar), bed temperature (50-80° C.) & time (30 minutes) post addition.

### Stability Testing

Multiple spray coating experiments were executed which yielded vinylic polymer coated Stainzyme composite particles for stability testing. Stability testing was performed in an acidic stain removing detergent media intended for domestic, commercial and institutional use. Standard ingredients of such media are: water, laureth-7, hydrogen peroxide, sodium C10-14 Alkyl Benzenesulfonate, laur-3, C12-15 Pareth-5, alcohol alkoxylate (EO/PO), perfume, etidronic acid, BHT, hexyl cinnamal, colorants. In addition to this, some stability testing was also performed in 6.5% hydrogen peroxide solution.

The test comprised of placing a known weight of enzyme containing composite into a known weight of liquid media where the inclusion level should not exceed 5% (w/w). All samples were assayed for amount of enzyme activity prior to testing. The composite samples were aged in the liquid media for 30 minutes, 60 minutes, 1 day and 3 days in a fan assisted stability oven at 40° C.

After the required elapsed time, samples were assessed as follows:
1. Gravimetric analysis of the retention of coated composites.
2. Combined gravimetric & chemical assay analyses of the coated composites.
3. Visual observation of the formulation.

The retention of Stainzyme® (amylase) was more accurately determined through combining the results of simultaneous gravimetric and chemical assay analyses per equations 1, 2 & 3 below.

Stainzyme®(Initial)(g)=Weight of Added Coated Particles (g)×Stainzyme®(Initial)(%) Equation 1

Stainzyme®(Final)(g)=Weight of Recovered Coated Particles (g)×Stainzyme®(Final)(%) Equation 2

Retention (%)=[Stainzyme®(Initial)(g)/Stainzyme®(Final)(g)]×100 Equation 3

### Examples of Stability Results for Stainzyme® Composite Particles

The following composites were tested:

Composite A—Stainzyme coated with Example 13 of polymeric material.
Composite B—Stainzyme coated with Example 13 of polymeric material.
Composite C—Stainzyme coated with Example 16 of polymeric material.
Composite D—Stainzyme coated with Example 17 of polymeric material.

The stability of Composites A, B and C was tested in 6.5% hydrogen peroxide solution. The results are shown in FIGS. 1-3.

The stability of Composites A, B, C and D was tested in acidic stain removing detergent solution. The results are shown in FIGS. 4-7.

The similarity in the data for Composites A and B (which are both based on the same polymer Example 13) demonstrate the reproducibility of the system despite any variations in speed or coating between runs. From the examples presented above it is clear that the coatings formed from the pH responsive polymers of this invention are able to significantly increase the stability of a commercially usefully enzyme in both a commercial acidic liquid laundry detergent and in hydrogen peroxide solution. For comparison, without the protective coating the enzyme is deactivated completely within minutes.

Various modifications and variations of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are obvious to those skilled in the relevant fields are intended to be covered by the present invention.

1. A composite comprising one or more core units, each core unit comprising an active agent and having a pH responsive, vinylic copolymer coating, wherein said active agent is selected from the group consisting of bleaching agents, anti-foaming agents, anti-redeposition aids, anti-microbials and biocides, enzymes, bleach catalysts, dye transfer inhibitors, optical brighteners, dyes, pigments, anti-scale and corrosion inhibiting ingredients, fragrances and perfumes, glass protectors, crop protection agents and agrochemicals.

2. A composite according to claim 1, wherein the core units are solid.

3. A composite according to claim 1, wherein the core units comprise single discrete particles, agglomerated particles, matrix particles and/or spheronised compositions.

4. A composite according to claim 1, wherein the active agent is a bleaching agent.

5. A composite according to claim 4, wherein the bleaching agent is a mono- or diperoxy acid, or a mixture thereof.

6. A composite according to claim 5, wherein the bleaching agent is phthalimido peroxy hexanoic acid.

7. A composite according to claim 1, wherein the active agent is an enzyme.

8. A composite according to claim 7, wherein the enzyme is selected from amylases, arabinosidases, bluco-amulases, cellulases, chondroitinases, cutinases, esterases, hydrolases, hemicellulases, isomerases, keratinases, lassases, lignases, lipases, lipooxygenases, lyases, malanases, mannanase, oxidases, oxidoreductases, pectinases, pentosanases, peroxidases, phenoloxidases, phospholipases, proteases, pullulanases, reductases, R-glucanases, tannases, transferases, xylanases, and mixtures thereof.

9. A composite according to claim 1, wherein the pH responsive, vinylic copolymer is insoluble at acidic and neutral pH values and soluble at basic pH values.

10. A composite according to claim 9, wherein the pH responsive, vinylic copolymer is soluble at pH≧0.5.

11. A composite according to claim 1 wherein the pH responsive, vinylic copolymer is prepared from monomers having only one polymerisable double bond.

12. A composite according to claim 11, wherein the pH responsive, vinylic copolymer is prepared from one or more of the following monomers: acrylic acid (AA), methacrylic acid (MAA), beta carboxy ethyl acrylate (BCEA), itaconic acid, maleic acid, maleic anhydride, itaconic anhydride, styrene, α-methyl styrene, methyl styrene, t-butyl styrene, alkyl esters of mono-olefinically unsaturated dicarboxylic acids, vinyl esters of carboxylic acids, acrylamides, methacrylamides, nitrile monomers, and esters of acrylic and methacrylic acid, including methyl acrylate, ethyl acrylate, n-butyl acrylate, 2-ethylhexyl acrylate, i-propyl acrylate, and n-propyl acrylate, methyl methacrylate, ethyl methacrylate, n-butyl methacrylate, 2-ethylhexyl methacrylate, i-propyl methacrylate, n-propyl acrylate, hydroxyethyl acrylate, hydroxyethyl methacrylate, hydroxyl butyl methacrylate, N,N-dimethylaminoethyl acrylate and N,N-dimethylaminoethyl methacrylate, diacetone acrylamide, glycidyl methacrylate, aceto acetoxy ethyl methacrylate, and mixtures thereof.

13. A composite according to claim 12, wherein the pH responsive, vinylic copolymer is prepared from one or more of the following monomers: methyl methacrylate (MMA), ethyl methacrylate (EMA), n-butyl methacrylate (BMA), iso-butyl methacrylate (iBMA), 2-ethylhexyl methacrylate (EHMA), 2-ethylhexyl acrylate (EHA), iso-bornyl methacrylate (iBoMA), methyl acrylate (MA), ethyl acrylate (EA), n-butyl acrylate (BA), styrene (STY), acrylic acid (AA), methacrylic acid (MAA), β-carboxy ethyl acrylate (β-CEA), and sodium acrylate (SAA), and mixtures thereof.

14. A composite according to claim 1, wherein the pH responsive, vinylic copolymer is a meth(acrylic) copolymer of general formula I:
—[(X)x-(Y)y-(Z)z]- (I)
wherein:
—(X)x-(Y)y-(Z)z- is a polymer backbone formed from the polymerization of X′, Y′ and Z′ monomers;
X′ is a first non-dissociating monomer of formula R3R4C═CR5-CO—OR6 or R3R4C═CR5R6;
Y′ is a second non-dissociating monomer of formula R3R4C═CR5-CO—OR6 or R3R4C═CR5R6;
Z′ is a dissociating monomer of formula R3R4C═CR5-CO2H or formula R3R4C═CR5-CO—O—(CH2)n-CO2H;
R3, R4 and R5 are each independently hydrogen or an inert aliphatic or aromatic organic moiety;
R6 is an inert aliphatic or aromatic organic moiety;
x is an integer from 30 to 90;
y is an integer from 0 to 50;
z is an integer from 10 to 60;
wherein x, y and z represent the % molar composition of components X, Y and Z respectively and the sum of x+y+z=100%.

15. A composite according to claim 14, wherein R3, R4, R5 are each independently hydrogen or an inert aliphatic or aromatic organic moiety selected from C1 to C20 alkyl or C6 to C8 aryl moieties, which moieties may be optionally substituted by a C1 to C6 linear or branched alkyl group, or a C6 to C10 aryl group.

16. A composite according to claim 14, wherein R6 is an inert aliphatic or aromatic organic moiety selected from C1 to C20 alkyl or C6 to C8 aryl moieties, which moieties may be optionally substituted by a C1 to C6 linear or branched alkyl group, or a C6 to C10 aryl group.

17. A process for preparing a composite according to claim 1, comprising applying a pH responsive, vinylic copolymer coating to the surface of one or more core units comprising an active agent selected from the group consisting of bleaching agents, anti-foaming agents, anti-redeposition aids, anti-microbials and biocides, enzymes, bleach catalysts, dye transfer inhibitors, optical brighteners, dyes, pharmaceuticals, pigments, anti-scale and corrosion inhibiting ingredients, fragrances and perfumes, glass protectors, crop protection agents and agrochemicals such as pesticides, herbicides, insecticides, fungicides, fertilizers, hormones and chemical growth agents, and mixtures thereof.

18. A composition comprising, a composite according to claim 1 and one or more active and/or non-active agents.

19. A solid or liquid auto-dishwasher product, which comprises a composite according to claim 1.

20. A solid or liquid auto-dishwasher product according to claim 19 comprising from about 0.5% to about 25% by weight of the composite.

21. A solid or liquid auto-dishwasher product according to claim 19, comprising an active agent selected from a bleaching agent, an enzyme, or a mixture thereof.

22. A solid or liquid laundry product comprising a composite according to claim 1.

23. A solid or liquid laundry product according to claim 22 comprising from about 0.5% to about 25% by weight of the composite.

24. A solid or liquid laundry product according to claim 22, comprising an active agent selected from a bleaching agent, enzyme, fragrance or perfume, or a mixture thereof.
